(19) United States
(12) Patent Application Publication
(10) Pub. No.: US 2025/0336154 A1
(43) Pub. Date: Oct. 30, 2025

(54) THREE-DIMENSIONAL RECONSTRUCTIONS BASED ON GAUSSIAN PRIMITIVES

(71) Applicant: Adobe Inc., San Jose, CA (US)

(72) Inventors: Kai Zhang, San Jose, CA (US); Hao Tan, San Jose, CA (US); Sai Bi, San Jose, CA (US); Zexiang Xu, San Jose, CA (US); Nanxuan Zhao, San Jose, CA (US); Kalyan Krishna Sunkavalli, San Jose (CA)

(73) Assignee: Adobe Inc., San Jose, CA (US)

(21) Appl. No.: 18/646,503

(22) Filed: Apr. 25, 2024

(51) Int. Cl. G06T 17/10; G06T 7/11; G06T 7/55

(52) U.S. Cl. CPC G06T 17/10; G06T 7/11; G06T 7/55; G06T 2200/24; G06T 2207/10024; G06T 2207/20081

(57) ABSTRACT

In implementation of techniques for three-dimensional reconstructions based on Gaussian primitives, a computing device implements a reconstruction system to receive a first digital image depicting an object from a first angle and a second digital image depicting the object from a second angle. The reconstruction system segments the first digital image and the second digital image into patches. The reconstruction system then generates, using a machine learning model, three-dimensional Gaussian primitives that predict parameters of points of the object in a three-dimensional space that correspond on a per-pixel basis to pixels of the patches. The reconstruction system then forms a three-dimensional reconstruction of the object for display in a user interface by merging the three-dimensional Gaussian primitives.

### BACKGROUND

In computer graphics, a three-dimensional reconstruction is a three-dimensional model formed from input images. The three-dimensional reconstruction, for instance, is a translation of an object or a scene depicted in a two-dimensional space into a three-dimensional space. Surfaces of the object or the scene are represented using polygon meshes or point clouds, and visual properties of the objects or the scenes are also represented in the three-dimensional reconstruction, including light reflection, color, and surface texture. Three-dimensional reconstructions are used in a variety of applications, including virtual reality, product design, architectural rendering, and animation. However, techniques involving generating three-dimensional reconstructions involve computational inefficiencies and visual inaccuracies in real world scenarios.

### SUMMARY

Techniques and systems for three-dimensional reconstructions based on Gaussian primitives are described. In an example, a reconstruction system receives a first digital image depicting an object or a scene from a first angle and a second digital image depicting the object or the scene from a second angle.

The reconstruction system segments the first digital image and the second digital image into patches. Using a machine learning model, the reconstruction system generates three-dimensional Gaussian primitives that predict parameters of points of the object or the scene in a three-dimensional space that correspond on a per-pixel basis to pixels of the patches. The machine learning model, for example, is a Transformer model that generates the three-dimensional Gaussian primitives by analyzing depicted depth and spatial relationships of the pixels of the patches. The machine learning model is trained on images depicting objects or scenes captured from multiple camera angles. Some examples further comprise processing the patches through a series of transformer models including self-attention and multilayer perceptron layers using the machine learning model for generating the three-dimensional Gaussian primitives.

The reconstruction system then forms a three-dimensional reconstruction of the object or the scene for display in a user interface by merging the three-dimensional Gaussian primitives. In some examples, merging the three-dimensional Gaussian primitives further comprises positioning points of the three-dimensional Gaussian primitives in the three-dimensional space using coordinates associated with the three-dimensional Gaussian primitives.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

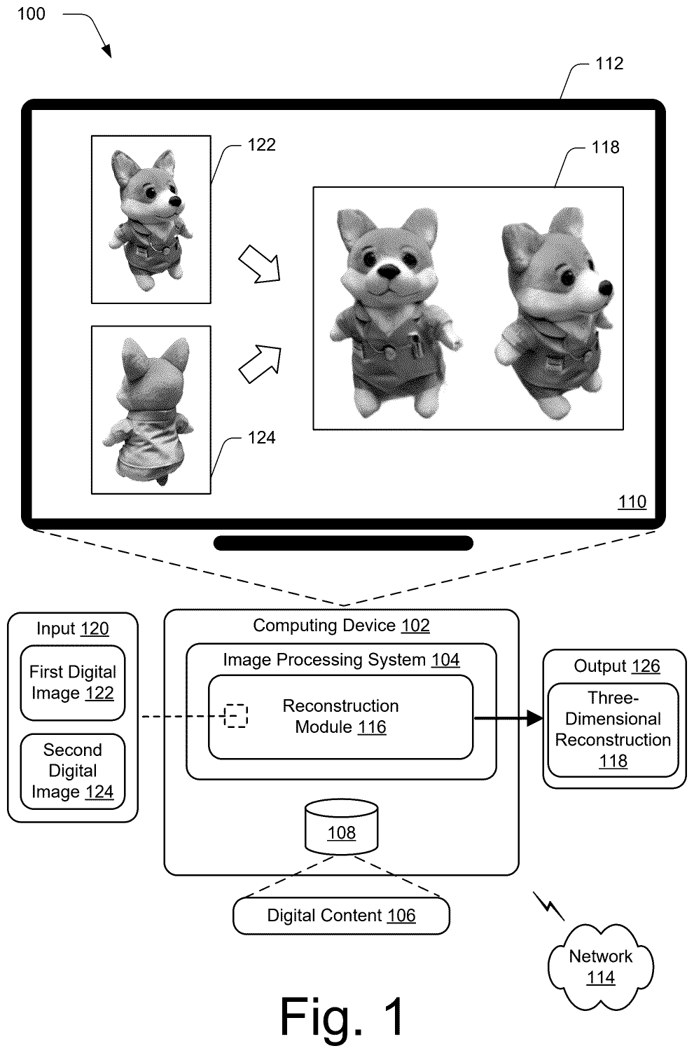

FIG. 1 is an illustration of a digital medium environment in an example implementation that is operable to employ techniques and systems for three-dimensional reconstructions based on Gaussian primitives as described herein.

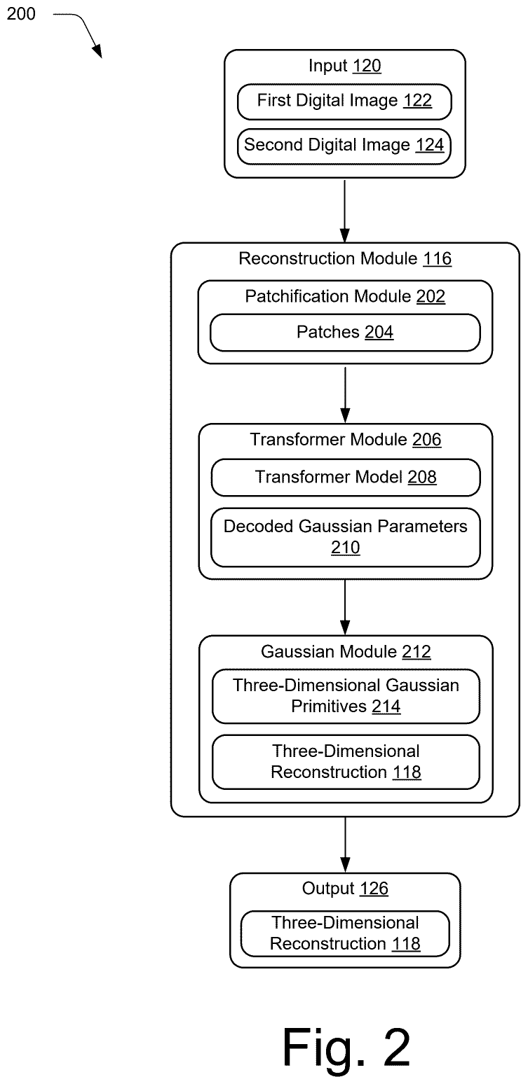

FIG. 2 depicts a system in an example implementation showing operation of a mesh progression module for three-dimensional reconstructions based on Gaussian primitives.

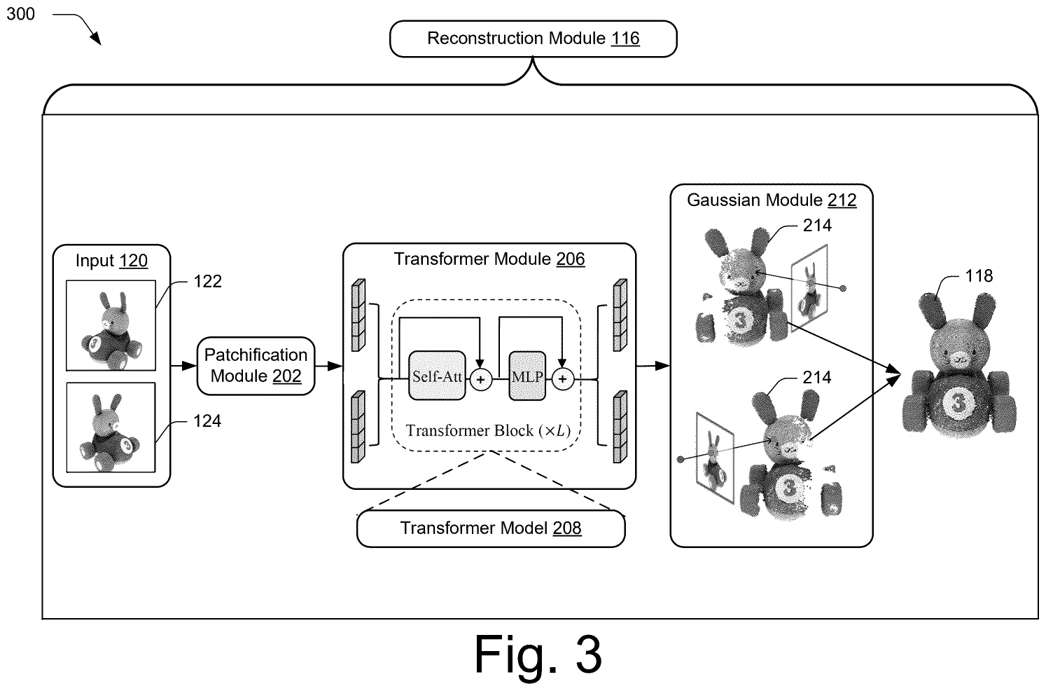

FIG. 3 depicts an example of an architecture for a reconstruction module.

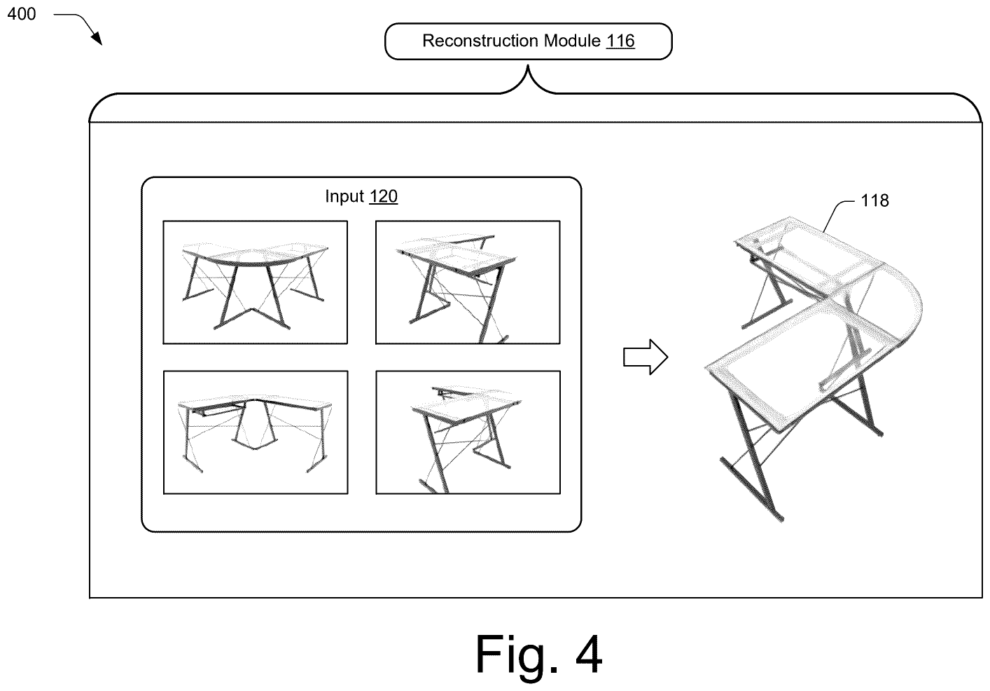

FIG. 4 depicts an example of forming a three-dimensional reconstruction of an object.

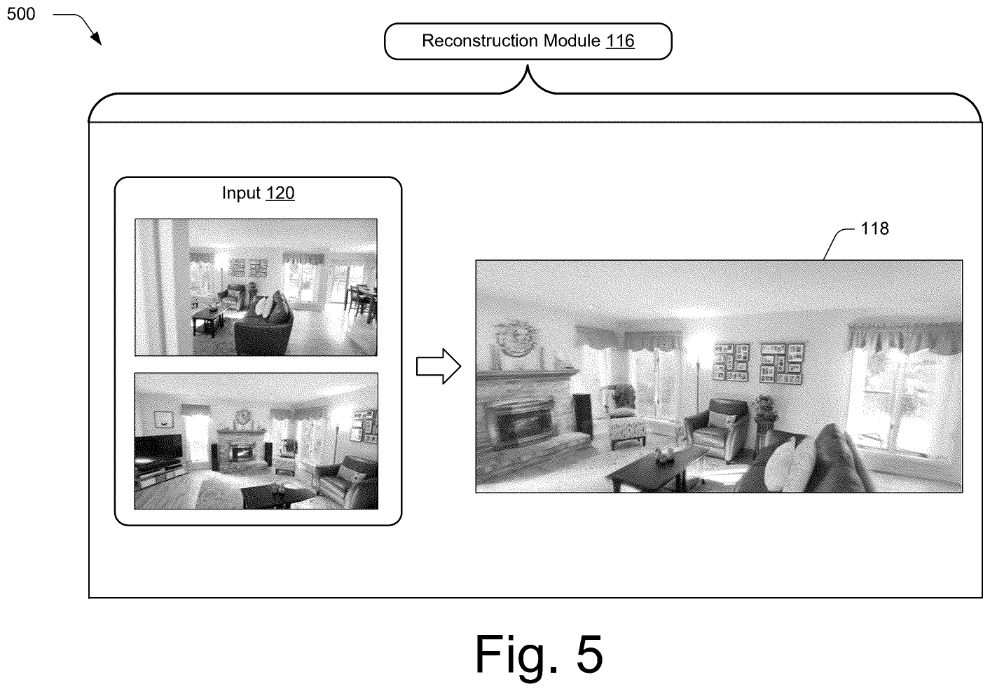

FIG. 5 depicts an example of forming a three-dimensional reconstruction of a scene.

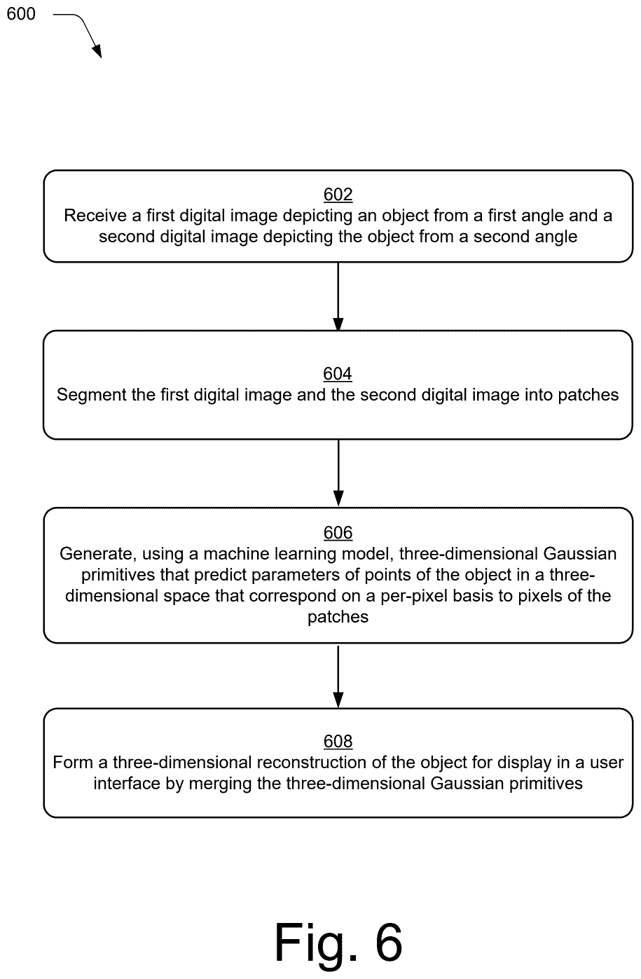

FIG. 6 depicts a procedure in an example implementation of three-dimensional reconstructions based on Gaussian primitives.

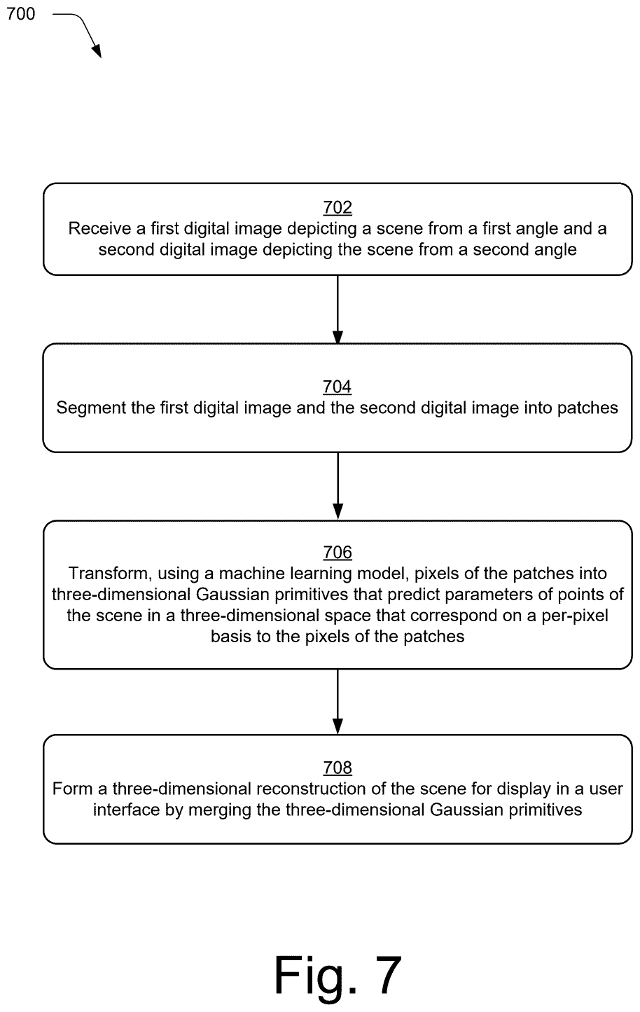

FIG. 7 depicts a procedure in an additional example implementation of three-dimensional reconstructions based on Gaussian primitives.

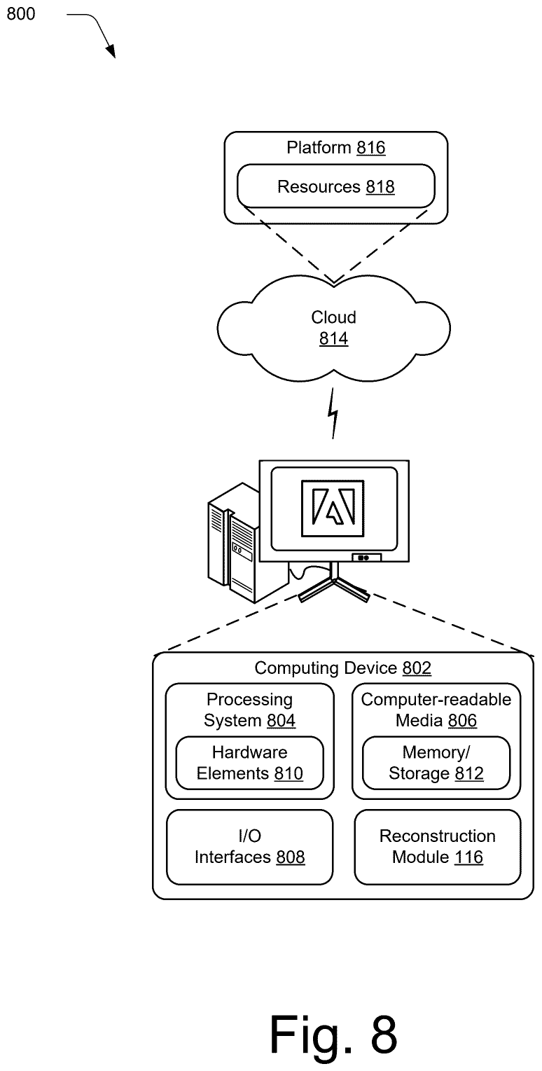

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

A reconstruction is a three-dimensional representation of an object or a scene depicted in a series of digital images. For instance, the three-dimensional reconstruction is a virtual model of the object or the scene in a three-dimensional space that is formed based on two-dimensional information. Reconstructions are used to create realistic elements in virtual environments for gaming, advertising, education, medicine, and engineering.

Conventional reconstruction techniques involve analyzing hundreds or thousands of input digital images on a per-image basis using a model to generate a single reconstruction. However, because of the processing resources involved in analyzing a large number of input digital images, the conventional reconstruction techniques are time-consuming and costly. Additionally, typical situations involving applications for reconstructing an object or a scene in a virtual three-dimensional environment do not involve access to large numbers of images of the object or the scene. For instance, a typical user desiring to generate a three-dimensional reconstruction of an object does not have the time or resources to capture hundreds or thousands of images of the object to input to a conventional reconstruction model.

Techniques and systems are described for generating reconstructions from digital video that overcome these limitations by receiving a sparse number of digital images as input to form a three-dimensional reconstruction. A sparse input includes fewer than ten input images, for example, or another number that is fewer than the large number of input digital images for conventional reconstruction techniques. A three-dimensional reconstruction system begins in this example by receiving a sparse input including two digital images that depict an object or a scene from different angles. In an example involving generating a three-dimensional reconstruction of an object, for instance, one of the digital images depicts a front view of the object, and another of the digital images depicts a side view of the object. The reconstruction system then patchifies the digital images, by segmenting the digital images into one-dimensional sequences of data called patches. The patches retain information related to pixels of the digital images, including color values of pixels depicting the object.

The reconstruction system then concatenates tokens based on the patches and inputs the tokens into a Transformer model, including a series of transformer blocks. The series of transformer blocks includes self-attention and multilayer perceptron layers that generate three-dimensional Gaussian primitives from the tokens. In this example, the Transformer model is trained on images depicting objects captured from multiple camera angles. The three-dimensional Gaussian primitives indicate points in a three-dimensional space based on coordinates or other positioning data determined through the series of transformer blocks. Because the three-dimensional Gaussians are generated on a per-pixel basis from pixels of the patches of the digital images, a three-dimensional Gaussian is predicted for a given corresponding point on the object.

To generate the three-dimensional reconstruction, the reconstruction system merges the three-dimensional Gaussian primitives together. The individual three-dimensional Gaussians, which represent individual points of a surface of the object, form a point cloud indicating a reconstructed surface of the object when plotted in a three-dimensional space, referred to as Gaussian Splatting. This accurately forms a three-dimensional reconstruction that visually converts surface features of objects or scenes depicted in two-dimensional images into a three-dimensional space. The three-dimensional representation is then available for rendering in a user interface, additional editing, or for further use with a variety of applications.

Generating reconstructions from digital video in this manner overcomes the disadvantages of conventional reconstruction techniques that involve large numbers of input digital images to generate a three-dimensional reconstruction. For example, segmenting input images into patches before generating three-dimensional Gaussian primitives that are merged together accurately forms a three-dimensional reconstruction without using a large number of input digital images, resulting in faster generation times than the conventional reconstruction techniques that process a large numbers of input digital images. By forming an accurate three-dimensional reconstruction based on sparse input digital images, the techniques described herein are also compatible with generating three-dimensional reconstructions from a sparse number of images generated by a two-dimensional generative model, which is not possible using conventional reconstruction techniques that involve large numbers of input digital images.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

FIG. 1 is an illustration of a digital medium environment 100 in an example implementation that is operable to employ techniques and systems for three-dimensional reconstructions based on Gaussian primitives described herein. The illustrated digital medium environment 100 includes a computing device 102, which is configurable in a variety of ways.

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 8.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a reconstruction module 116 which is illustrated as incorporated by the image processing system 104 to process the digital content 106. In some examples, the reconstruction module 116 is separate from the image processing system 104 such as in an example in which the reconstruction module 116 is available via the network 114.

The reconstruction module 116 is configured to generate a three-dimensional reconstruction 118. For example, the reconstruction module 116 first receives an input 120 including a first digital image 122 and second digital image 124. The first digital image 122 and the second digital image 124 depict an object from a first angle and a second angle, respectively. For instance, the first digital image 122 and the second digital image 124 are captured using a camera that changes positions relative to the object to capture images of the object from different angles. In other examples, the reconstruction module 116 receives more than two input digital images. In some examples, the reconstruction module 116 also receives Plücker rays, which indicate angles of capture for the first digital image 122 and the second digital image 124. A Plücker ray, for instance, indicates a direction and a location of a camera ray from a camera used to capture the first digital image 122 or the second digital image 124. In this example, the first digital image 122 depicts a dog from a front view, and the second digital image 124 depicts the dog from a rear view. Alternatively, in some examples, the first digital image 122 and the second digital image 124 depict a scene captured from different angles.

After receiving the first digital image 122 and the second digital image 124, the reconstruction module 116 segments the first digital image 122 and the second digital image 124 into patches. To do this, the reconstruction module 116 patchifies the first digital image 122 and the second digital image 124, which are two-dimensional images, into the patches, which are one-dimensional sequences of data. In some examples, the patches include groups of pixels from the first digital image 122 and the second digital image 124 and include information about the pixels, including color, opacity, depth, and other visual or spatial aspects.

The reconstruction module 116 uses a machine learning model to generate three-dimensional Gaussian primitives based on the patches. To do this, the reconstruction module 116 concatenates the patches into a series of tokens, which are input to the machine learning model that includes a transformer model with a series of transformer blocks in this example. The machine learning model generates conceptualized tokens based on the series of tokens. The machine learning model then predicts three-dimensional Gaussian primitives based on the conceptualized tokens by using the patches to analyze mutual information between the patches via self-attention, as explained in further detail with respect to FIG. 3. The three-dimensional Gaussian primitives indicate individual points in a three-dimensional space that correspond to points of a surface of the object, which correspond on a per-pixel basis to the pixels of the patches. In some examples, the three-dimensional Gaussian primitives also include coordinates indicating a position or placement of the Gaussian primitives in a three-dimensional space. Because the three-dimensional Gaussian primitives correspond to a point of a surface of the object depicted in the first digital image 122 and the second digital image 124, the three-dimensional Gaussian primitives also indicate information related to color, opacity, or other aspects of the points of the surface of the object depicted in the first digital image 122 and the second digital image 124. Additionally, in some examples, the machine learning model leverages information from the Plücker rays to determine depicted depths of the pixels.

The reconstruction module 116 then generates an output 126 including the three-dimensional reconstruction 118 by merging the three-dimensional Gaussian primitives. To do this, the reconstruction module 116 plots the three-dimensional Gaussian primitives in one three-dimensional space. Because the three-dimensional Gaussian primitives are points with coordinates indicating a position in a three-dimensional space, the three-dimensional Gaussian primitives form the three-dimensional reconstruction 118 of the object once plotted together, also referred to as Gaussian Splatting. In this example, the three-dimensional reconstruction 118 is a three-dimensional reconstruction of the dog that illustrates surfaces of the dog in three dimensions. The three-dimensional reconstruction 118, for instance is output for display in the user interface 110. In some examples, the three-dimensional reconstruction 118 is rendered into two-dimensional images. For instance, the machine learning model is trained by computing a loss from the rendered two-dimensional images and backpropagated through the renderer to train the transformer model.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Three-Dimensional Reconstructions Based on Gaussian Primitives

FIG. 2 depicts a system 200 in an example implementation showing operation of the reconstruction module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-8.

To begin in this example, a reconstruction module 116 receives an input 120 including a first digital image 122 and a second digital image 124. The first digital image 122 and the second digital image 124, depict different angles of an object or a scene that is the subject of the reconstruction. The different angles of the object, for example, indicate different views of different surfaces of the object used to reconstruct the object in a three-dimensional space. The first digital image 122 and the second digital image 124 are collections of pixels that indicate color values of points corresponding to the points of the surface of the object. In other examples, the reconstruction module 116 receives two or more digital images as input. In some examples, the first digital image 122 and the second digital image 124 are generated from a text input by a generative model.

The reconstruction module 116 includes a patchification module 202 that generates patches 204 by segmenting the first digital image 122 and the second digital image 124. Because the first digital image 122 and the second digital image 124 are two-dimensional digital images, the patchification module 202 involves patchifying the first digital image 122 and the second digital image 124 into patches of data that are one-dimensional and are smaller than the two-dimensional digital images.

The reconstruction module 116 also includes a transformer module 206. The transformer module 206 leverages a transformer model 208 including transformer blocks to generate decoded Gaussian parameters 210. To do this, the transformer module 206 concatenates the patches into a series of tokens, which are input to the transformer model 208, which is described in further detail with respect to FIG. 3. The transformer model 208 generates conceptualized tokens based on the series of tokens and then predicts the decoded Gaussian parameters 210 based on the conceptualized tokens.

The reconstruction module 116 also includes a Gaussian module 212 that generates three-dimensional Gaussian primitives 214 based on the decoded Gaussian parameters 210. The decoded Gaussian parameters 210 indicate individual points in a three-dimensional space that correspond to points of a surface of the object, which correspond on a per-pixel basis to the pixels of the patches 204. The three-dimensional Gaussian primitives 214, for instance, have coordinates indicating a position in a three-dimensional space that correspond to specific points of the object. The Gaussian module 212 then merges the three-dimensional Gaussian primitives 214 to form a three-dimensional reconstruction 118. To do so, the Gaussian module 212 plots points corresponding to the three-dimensional Gaussian primitives 214 on a common set of three-dimensional coordinate planes. Together, the three-dimensional Gaussian primitives 214 form the three-dimensional reconstruction 118, which a point cloud of individual points representing three-dimensional surfaces of the object. The reconstruction module 116 then generates an output 126 including the three-dimensional reconstruction 118 for display in a user interface 110.

FIGS. 3-5 depict stages of three-dimensional reconstructions based on Gaussian primitives. In some examples, the stages depicted in these figures are performed in a different order than described below.

FIG. 3 depicts an example 300 of an architecture for a reconstruction module. As illustrated, the reconstruction module 116 receives an input 120 including a first digital image 122 and a second digital image 124. The first digital image 122 and the second digital image 124, depict different angles of an object or a scene that is the subject of the reconstruction. The different angles of the object, for example, indicate different views of different surfaces of the object used to reconstruct the object in a three-dimensional space. The first digital image 122 and the second digital image 124 are collections of pixels that indicate color values of points corresponding to the points of the surface of the object. In this example, the object is a rabbit-shaped toy, the first digital image 122 depicts a surface of the rabbit-shaped toy captured from one direction, and the second digital image 124 depicts a second surface of the rabbit-shaped toy captured from a different direction. In other examples, the reconstruction module 116 receives two or more digital images as input.

A patchification module 202 of the reconstruction module 116 then receives the first digital image 122 and the second digital image 124 to generate patches 204 by segmenting the first digital image 122 and the second digital image 124. Because the first digital image 122 and the second digital image 124 are two-dimensional digital images, the patchification module 202 involves patchifying the first digital image 122 and the second digital image 124 into patches of data that are one-dimensional and are smaller than the two-dimensional digital images from the input 120. The patches, for instance, include data describing visual characteristics of the surface of the object from the pixels of the first digital image 122 and the second digital image 124.

A transformer module 206 of the reconstruction module 116 then receives the patches as input. The transformer module 206 leverages a transformer model 208 including transformer blocks to generate decoded Gaussian parameters 210. To do this, the transformer module 206 concatenates the patches into a series of tokens using a patchify operator for input to the transformer model 208.

To generate the series of tokens, the inputs to the transformer model 208 are N multi-view images {Iᵢ∈ [symbol] ^{H×W×3}|i=1, 2, . . . , N}, including intrinsic and extrinsic parameters of the camera used to capture the first digital image 122 and the second digital image 124, where H and W are the height and width of the first digital image 122 and the second digital image 124. Plücker ray coordinates of the first digital image 122 and second digital image 124 {Pᵢ∈ [symbol] ^{H×W×6}} are also computed from the camera parameters for pose conditioning. The transformer module 206 concatenates the image RGBs and the Plücker coordinates channel-wise, enabling per-pixel pose conditioning and forming a per-view feature map with nine channels. The patchification module 202 patchifies the inputs by dividing the per-view feature map into non-overlapping patches with a patch size of p. The patchification module 202 flattens the two-dimensional patches into a one-dimensional vector with a length of p²·9, and linear layer, and then maps the one-dimensional vectors to image patch tokens of d dimensions, where d is the transformer width, expressed as:

$${\{ {T}_{ij} \}}_{j = 1 , 2 , … , Hw / {p}^{2}} = Linear ( {Patchify}_{p} ( Concat ( {I}_{i} , {P}_{i} ) ) )$$

where {Tᵢⱼ∈ [symbol] ^{d}} denotes the set of patch tokens for image i, with a total number of HW/p² tokens (indexed by j) for the first digital image 122 and the second digital image 124. Because Plücker coordinates vary across pixels and views, they naturally serve as spatial embeddings to distinguish different patches. In this example, the patchification module 202 uses a patch size of 8×8 for the image tokenizer.

The transformer model 208, including blocks of self-attention and multilayer perceptron layers, generates conceptualized tokens based on the series of tokens and then predicts the decoded Gaussian parameters 210 based on the conceptualized tokens. For example, given the set of multi-view image tokens {Tᵢⱼ}, the transformer module 206 concatenates and feeds the multi-view image tokens through a chain of transformer blocks:

$${\{ {T}_{ij} \}}^{0} = \{ {T}_{ij} \} \\ {\{ {T}_{ij} \}}^{l} = {TransformerBlock}^{l} ( {\{ {T}_{ij} \}}^{l - 1} ) , l = 1 , 2 , … , L$$

where L is the total number of transformer blocks. Each transformer block is equipped with residual connections and consists of Pre-Layer Normalization, multi-head Self-Attention, and multilayer perceptron (MLP) layers. The transformer model 208 is trained to regress per-pixel three-dimensional Gaussian Splatting parameters from a set of images with known camera poses. In this example, the transformer model 208 has 24 layers, and the hidden dimension of 1024. The transformer blocks include a multi-head self-attention layer with 16 heads, and a two-layered MLP with GeLU activation, which weights inputs based on a percentile. The hidden dimension of the MLP is 4096. Both layers of the transformer model 208 are equipped with Pre-Layer Normalization.

A Gaussian module 212 than generates three-dimensional Gaussian primitives 214 based on the decoded Gaussian parameters 210. Using the output tokens {Tᵢⱼ}^{L} from the transformer, the transformer model 208 decodes the output tokens into the decoded Gaussian parameters 210 using a single linear layer:

$$\{ {G}_{ij} \} = Linear ( {\{ {T}_{ij} \}}^{L} )$$

where Gᵢⱼ∈ [symbol] ^{p}^{²}^{·q} represents the three-dimensional Gaussian primitives 214 and q is the number of parameters per Gaussian. The transformer model 208 then unpatchifies Gᵢⱼ into p² Gaussians. The patch size is p for patchifying and unpatchifying operations, resulting in HW Gaussians for the views, where a given two-dimensional pixel corresponds to a three-dimensional Gaussian primitive 214.

The three-dimensional Gaussian primitives 214 are parameterized by 3-channel RGB, 3channel scale, 4-channel rotation quaternion, 1-channel opacity, and 1-channel ray distance, resulting in q=12. For splatting rendering, a location of a Gaussian center of the three-dimensional Gaussian primitives 214 is obtained by the ray distance and the known camera parameters. Given t, ray ₒ, ray _{d} are the ray distance, ray origin, and ray direction, respectively, the center of the three-dimensional Gaussian primitives 214 is xyz=rayₒ+t·ray _{d}.

The decoded Gaussian parameters 210 indicate individual points in a three-dimensional space that correspond to points of a surface of the object, which correspond on a per-pixel basis to the pixels of the patches 204. The three-dimensional Gaussian primitives 214, for instance, have coordinates indicating a position in a three-dimensional space that correspond to specific points of the object.

The reconstruction module 116 then merges the three-dimensional Gaussian primitives 214 to form a three-dimensional reconstruction 118. For instance, the reconstruction module 116 merges the three-dimensional Gaussian primitives 214 from the N input views. Thus, the reconstruction module 116 outputs N·HW three-dimensional Gaussian primitives 214 in total. The number of the three-dimensional Gaussian primitives 214 scales up with increased input resolution and with number of input images. This property allows the reconstruction module 116 to handle high-frequency details in the inputs and large-scale scene captures, in contrast to conventional techniques that use a fixed-resolution triplane.

In this example, the three-dimensional reconstruction 118 is a three-dimensional representation of the rabbit-shaped toy. In a user interface, for instance, the three-dimensional reconstruction 118 is capable of being rotated or manipulated to view three-dimensional surfaces of the rabbit-shaped toy in a virtual three-dimensional environment.

During training, the transformer model 208 renders images at the M supervision views using the predicted Gaussian splats, and minimizes the image reconstruction loss. Given

$$\{ {I}_{{i}^{′}}^{*} \vert {i}^{′} = 1 , 2 , … , M \}$$

is a set of groundtruth views, and

$$\{ {\hat{I}}_{{i}^{′}}^{*} \}$$

represents the rendered images, the loss function is a combination of MSE (Mean Squared Error) loss and Perceptual loss:

$$ℒ = \frac{1}{M} {\sum }_{{i}^{′} = 1}^{M} ( M S E ( {\hat{I}}_{{i}^{′}}^{*} , {I}_{{i}^{′}}^{*} ) + λ \cdot Perceptual ( {\hat{I}}_{{i}^{′}}^{*} , {I}_{{i}^{′}}^{*} ) )$$

where λ is the weight of the perceptual loss.

In some examples, the reconstruction module 116 generates the three-dimensional reconstruction 118 at an object-level or at a scene-level. The three-dimensional reconstruction 118 at the object-level and the three-dimensional reconstruction 118 at the scene-level are formed using a shared architecture and training, but have differences in training data, view selection, and normalization.

To train the transformer model 208, the reconstruction module 116 uses Flashmixed-precision training with a BF16 data type. The Flashmixed-precision training, for instance, adjusts precision during training based on factors including gradient magnitudes. The reconstruction module 116 also applies deferred backpropagation for rendering the Gaussian splatting to save GPU memory. The model is pretrained with a resolution of 256×256 and fine-tuned with a resolution of 512×512. Fine-tuning the model architecture initializes the model with the pre-trained weights, but processes more tokens than the pre-training. At each training step, for the object-level, a set of 8 images are sampled (from 32 renderings) as a data point, and from 4 input views and 4 supervision views are selected independently. This sampling strategy encourages more overlap between input views and rendering views than directly sampling from 32 rendering views, which improves convergence of the transformer model 208. In this example, two random input views are selected and then randomly sampled for supervision views, using 6 supervision views per batch. The camera poses are normalized for scene-level input images. The transformer model 208 is further fine-tuned and takes 2-4 input images of 512×512 for generating visual results.

FIG. 4 depicts an example 400 of forming a three-dimensional reconstruction of an object. In this example, the reconstruction module 116 receives an input 120 including multiple digital images depicting different views of an object, which is a desk. The input 120 size is considered sparse because four digital images are included in the input 120, compared to hundreds or thousands of input digital images used by conventional techniques. The different views of the object, for example, are captured by different camera angles. For instance, the camera or other image capture device moves around the desk to capture the desk from a collection of different angles. Because the object is the subject of the input 120, the different views are directed inward toward the object.

To generate a three-dimensional reconstruction 118 of the desk, the reconstruction module 116 uses the patchification module 202, the transformer module 206, and the Gaussian module 212 introduced with respect to FIG. 2. The patchification module 202, for instance, generates patches 204 by segmenting the first digital image 122 and the second digital image 124 into patches of data that are one-dimensional and are smaller than the two-dimensional digital images. The patches, for instance, include data describing visual characteristics of the surface of the object from the pixels of the first digital image 122 and the second digital image 124.

The transformer module 206 leverages a transformer model 208 including transformer blocks to generate decoded Gaussian parameters 210. To do this, the transformer module 206 concatenates the patches into a series of tokens, which are input to the transformer model 208. The transformer model 208 generates conceptualized tokens based on the series of tokens and then predicts the decoded Gaussian parameters 210 based on the conceptualized tokens. As discussed above with respect to FIG. 3, the transformer model 208 is trained differently to generate the three-dimensional reconstruction 118 from objects versus scenes. In this example, because the input 120 includes digital images of an object, the transformer model 208 is trained on images depicting objects captured from multiple camera angles.

The Gaussian module 212 generates three-dimensional Gaussian primitives 214 based on the decoded Gaussian parameters 210, indicating individual points in a three-dimensional space that correspond to points of a surface of the object, which correspond on a per-pixel basis to the pixels of the patches 204. The Gaussian module 212 then merges the three-dimensional Gaussian primitives 214 to form a three-dimensional reconstruction 118 of the object by plotting points corresponding to the three-dimensional Gaussian primitives 214 on a common set of three-dimensional coordinate planes. Together, the three-dimensional Gaussian primitives 214 form the three-dimensional reconstruction 118, which is a point cloud of individual points representing three-dimensional surfaces of the desk in this example. The three-dimensional reconstruction 118 of the desk is displayed in a user interface for viewing, including rotating the desk to see surfaces and angles not represented in the digital images, or for further editing and manipulation.

FIG. 5 depicts an example 500 of forming a three-dimensional reconstruction of a scene. In this example, the reconstruction module 116 receives an input 120 including multiple digital images depicting different views of a scene, which is a living room. The input 120 size is considered sparse because two digital images are included in the input 120, compared to the hundreds or thousands of input digital images used by conventional techniques. The different views of the scene, for example, are captured by different camera angles. For instance, the camera or other image capture device moves around the room to capture the room from a collection of different angles. Because the room is the subject of the input 120, the different views are directed into the room, or directed outward showing walls of the room in some examples.

To generate a three-dimensional reconstruction 118 of the room, the reconstruction module 116 uses the patchification module 202, the transformer module 206, and the Gaussian module 212 introduced with respect to FIG. 2. The patchification module 202, for instance, generates patches 204 by segmenting the first digital image 122 and the second digital image 124 into patches of data that are one-dimensional and are smaller than the two-dimensional digital images. The patches, for instance, include data describing visual characteristics of the surface of the scene from the pixels of the first digital image 122 and the second digital image 124.

The transformer module 206 leverages a transformer model 208 including transformer blocks to generate decoded Gaussian parameters 210. To do this, the transformer module 206 concatenates the patches into a series of tokens, which are input to the transformer model 208. The transformer model 208 generates conceptualized tokens based on the series of tokens and then predicts the decoded Gaussian parameters 210 based on the conceptualized tokens. As discussed above with respect to FIG. 3, the transformer model 208 is trained differently to generate the three-dimensional reconstruction 118 from objects versus scenes. In this example, because the input 120 includes digital images of scene, the transformer model 208 is trained on images depicting scenes captured from multiple camera angles.

The Gaussian module 212 generates three-dimensional Gaussian primitives 214 based on the decoded Gaussian parameters 210, indicating individual points in a three-dimensional space that correspond to points of a surface of the scene, which correspond on a per-pixel basis to the pixels of the patches 204. The Gaussian module 212 then merges the three-dimensional Gaussian primitives 214 to form a three-dimensional reconstruction 118 of the scene by plotting points corresponding to the three-dimensional Gaussian primitives 214 on a common set of three-dimensional coordinate planes. Together, the three-dimensional Gaussian primitives 214 form the three-dimensional reconstruction 118, which is a point cloud of individual points representing three-dimensional surfaces of the room in this example. The three-dimensional reconstruction 118 of the room is displayed in a user interface for viewing, including rotating the room to see surfaces and angles not represented in the digital images, or for further editing and manipulation.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5.

FIG. 6 depicts a procedure 600 in an example implementation of three-dimensional reconstructions based on Gaussian primitives. At block 602 a first digital image 122 depicting an object from a first angle and a second digital image 124 depicting the object from a second angle are received. In some examples, the first digital image 122 and the second digital image 124 are generated from a text input by a generative model. Additionally or alternatively, some examples further comprise receiving Plücker rays indicating angles of capture for the first digital image 122 and the second digital image 124.

At block 604, the first digital image 122 and the second digital image 124 are segmented into patches 204. Some examples further comprise processing the patches 204 through a series of transformer models including self-attention and multilayer perceptron layers using the machine learning model for generating the three-dimensional Gaussian primitives 214.

At block 606, three-dimensional Gaussian primitives 214 are generated using a machine learning model that predict parameters of points of the object in a three-dimensional space that correspond on a per-pixel basis to pixels of the patches 204. For example, the machine learning model is a Transformer model 208 that generates the three-dimensional Gaussian primitives 214 by analyzing depicted depth and spatial relationships of the pixels of the patches 204. In some examples, the machine learning model is trained on images depicting objects captured from multiple camera angles. For example, the three-dimensional Gaussian primitives 214 have color values corresponding to colors of the pixels of the patches 204. Additionally or alternatively, some examples include generating the three-dimensional Gaussian primitives 214 by analyzing the Plücker rays to determine depicted depths of the pixels of the patches 204 using the machine learning model.

At block 608, a three-dimensional reconstruction 118 of the object is formed for display in a user interface 110 by merging the three-dimensional Gaussian primitives 214. In some examples, merging the three-dimensional Gaussian primitives 214 further comprises positioning points of the three-dimensional Gaussian primitives 214 in the three-dimensional space using coordinates associated with the three-dimensional Gaussian primitives 214.

FIG. 7 depicts a procedure 700 in an additional example implementation of three-dimensional reconstructions based on Gaussian primitives. At block 702, a first digital image 122 depicting a scene from a first angle and a second digital image 124 depicting the scene from a second angle are received. In some examples, the first digital image 122 and the second digital image 124 are generated from a text input by a generative model. Some examples further comprise receiving Plücker rays indicating angles of capture for the first digital image 122 and the second digital image 124.

At block 704, the first digital image 122 and the second digital image 124 are segmented into patches.

At block 706, pixels of the patches 204 are transformed, using a machine learning model, into three-dimensional Gaussian primitives 214 that predict parameters of points of the scene in a three-dimensional space that correspond on a per-pixel basis to the pixels of the patches 204. For example, the machine learning model is a Transformer model 208 that generates the three-dimensional Gaussian primitives 214 by analyzing depicted depth and spatial relationships of the pixels of the patches. For example, the machine learning model is trained on images depicting scenes captured from multiple camera angles. In some examples, the three-dimensional Gaussian primitives 214 have color values corresponding to colors of the pixels of the patches 204. Additionally or alternatively, some examples further comprise generating the three-dimensional Gaussian primitives 214 by analyzing the Plücker rays to determine depicted depths of the pixels of the patches using the machine learning model.

At block 708, a three-dimensional reconstruction 118 of the scene is formed for display in a user interface 110 by merging the three-dimensional Gaussian primitives 214. For example, merging the three-dimensional Gaussian primitives 214 further comprises positioning points of the three-dimensional Gaussian primitives 214 in the three-dimensional space using coordinates associated with the three-dimensional Gaussian primitives 214.

### Example System and Device

FIG. 8 illustrates an example system generally at 800 that includes an example computing device 802 that is representative of one or more computing systems and/or devices that implement the various techniques described herein. This is illustrated through inclusion of the reconstruction module 116. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices and/or processing systems 804) to implement techniques, modules, and examples described herein.

The techniques described herein are supported by various configurations of the computing device 802 and are not limited to the specific examples of the techniques described herein. This functionality is also implementable through use of a distributed system, such as over a “cloud” 1114 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized when computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

What is claimed is:

1. A method comprising:
receiving, by a processing device, a first digital image depicting an object from a first angle and a second digital image depicting the object from a second angle;
segmenting, by the processing device, the first digital image and the second digital image into patches;
generating, by the processing device using a machine learning model, three-dimensional Gaussian primitives that predict parameters of points of the object in a three-dimensional space that correspond on a per-pixel basis to pixels of the patches; and
forming, by the processing device, a three-dimensional reconstruction of the object for display in a user interface by merging the three-dimensional Gaussian primitives.

2. The method of claim 1, wherein the machine learning model is a Transformer model that generates the three-dimensional Gaussian primitives by analyzing depicted depth and spatial relationships of the pixels of the patches.

3. The method of claim 1, wherein the machine learning model is trained on images depicting objects captured from multiple camera angles.

4. The method of claim 1, wherein the three-dimensional Gaussian primitives have color values corresponding to colors of the pixels of the patches.

5. The method of claim 1, wherein merging the three-dimensional Gaussian primitives further comprises positioning points of the three-dimensional Gaussian primitives in the three-dimensional space using coordinates associated with the three-dimensional Gaussian primitives.

6. The method of claim 1, wherein the first digital image and the second digital image are generated from a text input by a generative model.

7. The method of claim 1, further comprising processing the patches through a series of transformer models including self-attention and multilayer perceptron layers using the machine learning model for generating the three-dimensional Gaussian primitives.

8. The method of claim 1, further comprising receiving Plücker rays indicating angles of capture for the first digital image and the second digital image.

9. The method of claim 8, further comprising generating the three-dimensional Gaussian primitives by analyzing the Plücker rays to determine depicted depths of the pixels of the patches using the machine learning model.

10. A system comprising:
a memory component; and
a processing device coupled to the memory component, the processing device to perform operations comprising:
receiving a first digital image depicting a scene from a first angle and a second digital image depicting the scene from a second angle;
segmenting the first digital image and the second digital image into patches;
transforming, using a machine learning model, pixels of the patches into three-dimensional Gaussian primitives that predict parameters of points of the scene in a three-dimensional space that correspond on a per-pixel basis to the pixels of the patches; and
forming a three-dimensional reconstruction of the scene for display in a user interface by merging the three-dimensional Gaussian primitives.

11. The system of claim 10, wherein the machine learning model is a Transformer model that generates the three-dimensional Gaussian primitives by analyzing depicted depth and spatial relationships of the pixels of the patches.

12. The system of claim 10, wherein the machine learning model is trained on images depicting scenes captured from multiple camera angles.

13. The system of claim 10, wherein the three-dimensional Gaussian primitives have color values corresponding to colors of the pixels of the patches.

14. The system of claim 10, wherein merging the three-dimensional Gaussian primitives further comprises positioning points of the three-dimensional Gaussian primitives in the three-dimensional space using coordinates associated with the three-dimensional Gaussian primitives.

15. The system of claim 10, wherein the first digital image and the second digital image are generated from a text input by a generative model.

16. The system of claim 10, further comprising receiving Plücker rays indicating angles of capture for the first digital image and the second digital image and generating the three-dimensional Gaussian primitives by analyzing the Plücker rays to determine depicted depths of the pixels of the patches using the machine learning model.

17. A non-transitory computer-readable storage medium storing executable instructions, which when executed by a processing device, cause the processing device to perform operations comprising:
receiving a first digital image depicting an object from a first angle and a second digital image depicting the object from a second angle;
segmenting the first digital image and the second digital image into patches;
generating, using a machine learning model, three-dimensional Gaussian primitives that predict parameters of points of the object in a three-dimensional space corresponding to pixels of the patches by analyzing depicted depth and spatial relationships of the pixels of the patches; and
forming a three-dimensional reconstruction of the object for display in a user interface by merging the three-dimensional Gaussian primitives.

18. The non-transitory computer-readable storage medium of claim 17, wherein the machine learning model is trained on images depicting objects captured from multiple camera angles.

19. The non-transitory computer-readable storage medium of claim 17, wherein the three-dimensional Gaussian primitives have color values corresponding to colors of the pixels of the patches.

20. The non-transitory computer-readable storage medium of claim 17, wherein merging the three-dimensional Gaussian primitives further comprises positioning points of the three-dimensional Gaussian primitives in the three-dimensional space using coordinates associated with the three-dimensional Gaussian primitives.
